(19) United States
(12) Patent Application Publication
(10) Pub. No.: US 2018/0270448 A1
(43) Pub. Date: Sep. 20, 2018

(54) IMAGE PROCESSING SYSTEM

(71) Applicant: CANON KABUSHIKI KAISHA, Tokyo (JP)

(72) Inventor: Hidetoshi Onuma, Tokyo (JP)

(21) Appl. No.: 15/921,135

(22) Filed: Mar. 14, 2018

(30) Foreign Application Priority Data
Mar. 16, 2017 (JP) 2017-051711

(51) Int. Cl. H04N 7/01; G06F 3/14

(52) U.S. Cl. CPC H04N 7/0122; H04N 7/0135; G06F 3/1423

(57) ABSTRACT

The present invention provides an image processing system includes a first image processing device and a second image processing device. The second image processing device includes: a combining unit that generates combined image data by combining captured image data input via a first input terminal and assistant image data input via a second input terminal; and a converting unit that generates image data of a first resolution to be output to a third output terminal and image data of a second resolution to be output to a fourth output terminal by converting a resolution of the combined image data generated by the combining unit in accordance with a display resolution of a first display device and a display resolution of a second display device.

### BACKGROUND OF THE INVENTION

### Field of the Invention

The present invention relates to image processing, and in particular to a technique for outputting an image to a plurality of image display devices.

### Description of the Related Art

In recent years, image capturing apparatuses, such as digital video cameras and digital cameras, include a plurality of components related to image output, examples of which include an electronic viewfinder arranged in an eyepiece unit, a liquid crystal panel arranged on a back surface or a side surface, and an output terminal (e.g., HDMI) connected to a television or a display. Generally, the specifications of digital video cameras enable images to be output simultaneously from the electronic viewfinder, the liquid crystal panel, and the image output terminal (e.g., HDMI). Furthermore, in some models of digital cameras on the market, images can be output simultaneously from the liquid crystal panel and the image output terminal (e.g., HDMI) in order to deal with monitoring and external recording by an external device, especially when shooting moving images. Under such circumstances, an image processing device has been suggested that retains, in a DRAM or other buffer memories, image data that has been generated within the image processing device in accordance with each output, and outputs images simultaneously in response to requests from their respective output destinations (for example, Japanese Patent Laid-Open No. 2004-165876).

There has been an increase in the number of display pixels in an electronic viewfinder and a liquid crystal panel installed in recent image capturing apparatuses. Furthermore, image output terminals (e.g., HDMI) are starting to have, for example, 4K output capabilities. An increase in the number of pixels to be processed means an increase in the usage rate of a band of a memory used within a device. Therefore, if one image processing device attempts to output a plurality of images having a higher than ever resolution, there will be a possibility that the band of the memory is used up and normal output cannot be performed.

### SUMMARY OF THE INVENTION

According to an aspect of the invention, there is provided an image processing system, comprising: a first image processing device including a first output terminal that outputs captured image data obtained through image capture, and a second output terminal that outputs assistant image data to be combined with an image based on the captured image data; and a second image processing device including a first input terminal connected to the first output terminal, a second input terminal connected to the second output terminal, a third output terminal connectable to a first display device, and a fourth output terminal connectable to a second display device, wherein the second image processing device further includes a combining unit that generates combined image data by combining the captured image data input via the first input terminal and the assistant image data input via the second input terminal, and a converting unit that generates image data of a first resolution to be output to the third output terminal and image data of a second resolution to be output to the fourth output terminal by converting a resolution of the combined image data generated by the combining unit in accordance with a display resolution of the first display device and a display resolution of the second display device.

Further features of the present invention will become apparent from the following description of exemplary embodiments (with reference to the attached drawings).

### BRIEF DESCRIPTION OF THE DRAWINGS

FIG. 1 is a block configuration diagram of an image processing system according to a first embodiment.

FIGS. 2A-2D are diagrams showing data structures of image data and OSD data.

FIG. 3 is a block configuration diagram of an image processing system according to a second embodiment.

FIG. 4 is a block configuration diagram of an image processing system according to a third embodiment.

FIG. 5 is a block configuration diagram of an image processing system according to a fourth embodiment.

### DESCRIPTION OF THE EMBODIMENTS

The following describes embodiments of the present invention in detail in accordance with the attached drawings. Although the description pertains to an example in which a video camera (image capturing apparatus) is used, it is sufficient to use an apparatus that has a function of outputting an image to a plurality of display devices, rather than being limited particularly to a video camera.

### First Embodiment

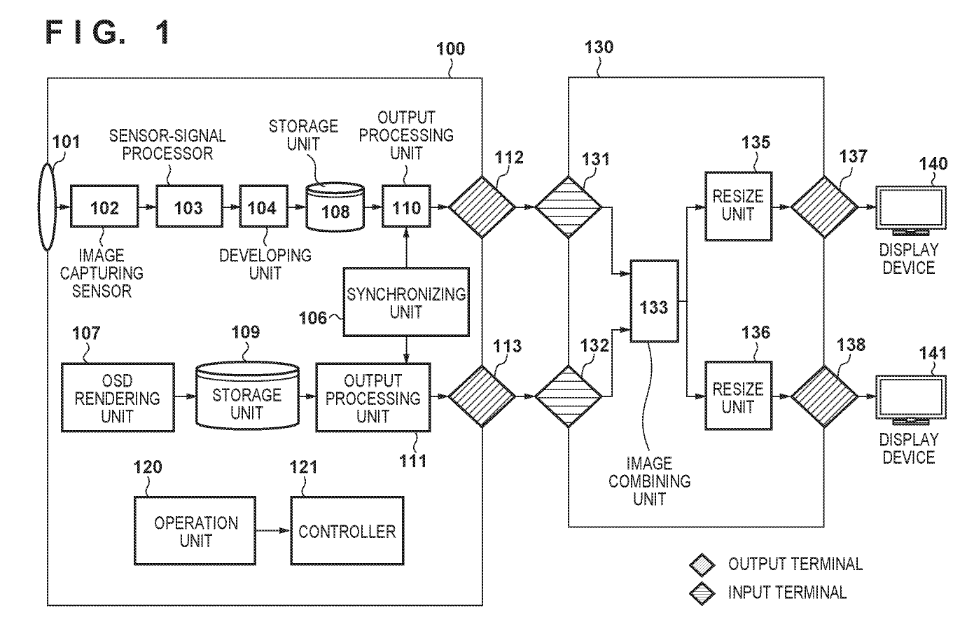

FIG. 1 is a block diagram of an image processing system held by a video camera according to an embodiment of the present invention. The present system includes two image processing devices 100, 130.

The image processing device 100 has functions of capturing an image of a subject, executing development processing, and outputting image information to the outside. A controller 121 in the image processing device 100 includes a CPU and a memory that stores control programs executed by the CPU, and controls the entire processing of the image processing device 100. An operation unit 120 includes input devices, such as keys, buttons, and a touchscreen that are used by a user to issue an instruction to the image processing device 100. An operation signal from the operation unit 120 is detected by the controller 121, and the controller 121 performs control to execute a performance corresponding to an operation.

Upon issuance of an instruction for starting a shooting performance via the operation unit 120, an optical image of a subject targeted for image capture is input via an image capturing optical unit 101 and formed on an image capturing sensor 102. An electrical signal converted by the image capturing sensor 102 is supplied to a sensor-signal processor 103. The sensor-signal processor 103 converts the input electrical signal into digital data, and executes pixel restoration processing. The restoration processing includes processing for, with respect to values of missing pixels and pixels with low reliability in the image capturing sensor 102, interpolating pixels to be restored using surrounding pixel values and subtracting a predetermined offset value. Upon receiving data output from the sensor-signal processor 103, a developing unit 104 executes so-called development processing for image optimization including, for example, conversion into a color space composed of luminance and chrominance, removal of noise included in each piece of data, and correction of optical distortion. Furthermore, the developing unit 104 temporarily stores image data after the development processing to a storage unit 108. One typical form of the storage unit 108 is a DRAM. In accordance with an instruction from a synchronizing unit 106, an output processing unit 110 reads out image data from the storage unit 108 at a set timing and outputs the image data to the outside of the image processing device 100 via an output terminal 112. In accordance with input of an instruction from the user via the operation unit 120, an OSD rendering unit 107 renders a menu that is displayed in a superimposed manner on an image (captured image) to be displayed, ruling lines for shooting assistance, a timecode, and so on. OSD data rendered by the OSD rendering unit 107 is temporarily retained in a storage unit 109. One typical form of the storage unit 109 is a DRAM. In accordance with an instruction from the synchronizing unit 106, an output processing unit 111 reads out OSD data from the storage unit 109 at a set timing and outputs the OSD data to the outside of the image processing device 100 via an output terminal 113.

Note that both of the output terminals 112, 113 output data in units of pixels. Hereinafter, in order to distinguish between these two, image data output from the output terminal 112 will be referred to as captured image data, whereas OSD data output from the output terminal 113 will be referred to as OSD image data.

Furthermore, when captured image data and OSD image data that are output from the image processing device 100 to the image processing device 130 have the same resolution, it is sufficient for the synchronizing unit 106 to generate a timing signal for outputting their respective pixels in synchronization. Note that in general, it is sufficient to distinguish among characters and other symbols that compose an OSD image, and in many cases, they do not require a resolution that is as high as captured image data. For example, assume a case where captured image data is composed of W pixels in the horizontal direction and H pixels in the vertical direction, whereas OSD image data has W/4 pixels in the horizontal direction and H/4 pixels in the vertical direction. In this case, the synchronizing unit 106 supplies, to the output processing unit 111, a timing signal for outputting one horizontal pixel of the OSD image data each time four pixels of the captured image data in the horizontal direction are output. Furthermore, it is sufficient for the synchronizing unit 106 to supply, to the output processing unit 111, a timing signal for outputting one line of the OSD image data in the vertical direction each time four lines of the captured image data in the vertical direction are output. At a timing when one pixel of captured image data is input from the image processing device 100, the image processing device 130 also receives OSD image data. As a result, in association with 4×4 pixel data of captured image data, 4×4 pieces of OSD pixel data composed of the same pixel values and coefficient values is input to the image processing device 130.

A description is now given of the other image processing device 130. This image processing device 130 is installed as an integrated circuit chip, for example, an SPGA (System Programmable Gate Array), in the video camera. It may be installed as an FPGA (Field Programmable Gate Array) in the video camera.

The image processing device 130 receives captured image data and OSD image data output from the aforementioned image processing device 100, generates combined image data, and outputs the combined image data to a display device 140 and a display device 141. Note that the display devices 140, 141 according to the embodiment will be described as display devices with different resolutions.

An input terminal 131 receives captured image data output from the output terminal 112 of the image processing device 100. An input terminal 132 receives OSD image data output from the output terminal 113 of the image processing device 100. An image combining unit 133 combines the captured image data and the OSD image data in accordance with coefficient data (described later in detail) that is included in the OSD image data and indicates a combining ratio. The synchronizing unit 106 can perform timing control so as to minimize a wait period for combining the captured image data and the OSD image data. A resize unit 135 resizes (converts the resolution of) the captured image data after the OSD combining, which has been generated by the image combining unit 133, into an angle of view (resolution) corresponding to a request from the display device 140, and outputs the resultant captured image data to the display device 140 via an output terminal 137. Similarly, a resize unit 136 resizes the captured image data after the OSD combining, which has been generated by the image combining unit 133, into an angle of view corresponding to a request from the display device 141, and outputs the resultant captured image data to the display device 141 via an output terminal 138.

The display device 140 is, for example, an electronic viewfinder arranged in an eyepiece unit of the image capturing apparatus, whereas the display device 141 is, for example, a liquid crystal panel arranged on a back surface or a side surface of the image capturing apparatus. Examples of the output terminals 137, 138 include professional-use SDIs that can transmit video data and audio data, and interfaces (e.g., HDMI and DVI) that can perform bidirectional communication and obtain resolutions from the display devices.

As explained earlier, the storage unit 108 stores only captured image data, and the storage unit 109 stores only OSD image data. Even when a plurality of (two in the embodiment) display devices are connected, the captured image data and the OSD image data are read out once from their respective storage units per frame of captured images; this makes it possible to put a restraint on bands for accessing the storage unit 108 and the storage unit 109.

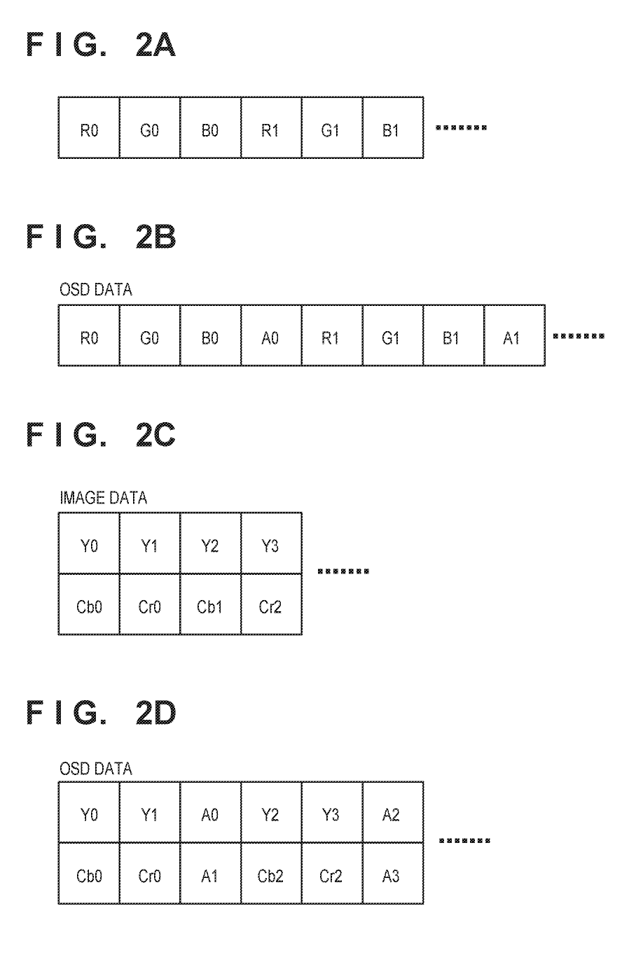

Image data output from the output terminals 112, 113 will now be described. When one pixel of captured image data is composed of, for example, three components R, G, B, the output terminal 112 performs output in the order of {R, G, B} in units of pixels as shown in FIG. 2A.

On the other hand, OSD image data is data obtained by adding a coefficient that indicates combining (a value indicating a combining ratio) to image data indicating OSD, such as characters, symbols, and lines. Therefore, as shown in FIG. 2B, a combining coefficient A is output subsequent to data of components R, G, B. That is to say, in the case of OSD data, when the number of pixels in the horizontal direction is counted with each of R, G, B considered as one, the number of pixels in the RGBA OSD data in the horizontal direction is 4/3 as large as that in the RGB image data. The above-described image combining unit 133 combines the RGB values of pixels in the captured image data and the RGB values of pixels indicated by the OSD image data in accordance with the coefficient A added to the OSD image data. Provided that each component is expressed using 8 bits (the maximum value being 255) and the captured image data and the OSD image data are respectively denoted by I₁ and I₂, the image combining unit 133 generates a post-combining image I₃ in accordance with the following expression: I₃(x,y,C)={A×I₁(x,y,C)+(255−A)×I₂(x,y,C)}/255. Here, x denotes a coordinate in an image in the horizontal direction, y denotes a coordinate in the same in the vertical direction, and C denotes one of the color components {R, G, B}. It will be assumed that the values of R, G, B and the coefficient A in the OSD image data are set by the user via the operation unit 120.

Furthermore, when the captured image data is YCC as shown in FIG. 2C, the OSD image data can be expressed as YCCA as shown in FIG. 2D provided that the combining coefficient is A. The example of YCC shown in FIG. 2D is YCC422, with data of A being the same in number as Y. When the number of pixels in the horizontal direction is counted based on Y in accordance with the practice of YCC422, the number of images of YCCA in the OSD data in the horizontal direction is 3/2 as large as that in the YCC422 image data. Although FIGS. 2A to 2D illustrate a typical format of OSD image data as an example, the present embodiment can be applied to a format other than this example.

The synchronizing unit 106 in FIG. 1 can facilitate image combining processing executed in the image processing device 130 by achieving consistency between transfer start timings for image data output from the output terminal 112 as well as OSD data output from the output terminal 113 in the horizontal direction and a transfer period.

As described above, according to the present first embodiment, the image processing system can output an image obtained combined with an assistant image to a plurality of display devices with different resolutions while suppressing a strain on a band of a memory for temporarily storing an image to be displayed. Captured image data is temporarily stored to the storage unit 108, and OSD image data is stored to the storage unit 109. However, even when image data after the OSD combining is displayed on a plurality of different display devices, image data is read out from each storage unit once per frame of moving images; this makes it possible to suppress a strain on memory bands of the storage units.

Although the description of the foregoing embodiment pertains to an example in which two display devices are connectable to the image processing device 130, more display devices may be connectable thereto. In this case, the image processing device 130 includes as many resize units as the connectable display devices.

### Second Embodiment

In the foregoing first embodiment, captured image data is combined with OSD at different resolutions of a plurality of display devices, and the resultant captured image data is output to the plurality of display devices. The present second embodiment describes an example that makes it possible to set whether to combine OSD separately on a per-display device basis.

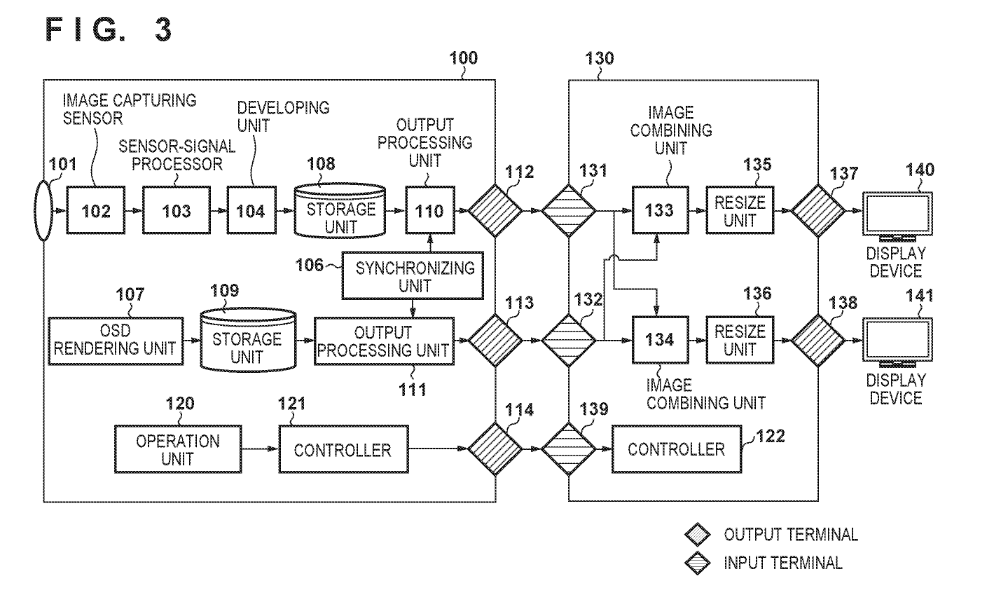

FIG. 3 is a system configuration diagram according to the present second embodiment. Differences from FIG. 1 lie in that an output terminal 114 is added to the image processing device 100, and an input terminal 139, a controller 122, and an image combining unit 134 are added to the image processing device 130. Other parts are the same as in the first embodiment. Therefore, the following describes differences from the first embodiment.

The user can set whether to superimpose OSD with respect to each of the display devices 140, 141 separately by operating the operation unit 120. The controller 121 notifies the image processing device 130 of information that has been thus set by the user (OSD setting information) via the output terminal 114. The controller 122 in the image processing device 130 receives this OSD setting information via the input terminal 139. Then, the controller 122 outputs a control signal indicating ON/OFF of combining processing to each of the image combining units 133, 134 independently.

Upon receiving a signal that turns ON the combining processing, the image combining unit 133 combines OSD image data received via the input terminal 132 and captured image data in accordance with a combining ratio indicated by a coefficient A in the OSD image data, and outputs the combining result to the resize unit 135. On the other hand, upon receiving a signal that turns OFF the combining processing, the image combining unit 133 outputs the captured image data input from the input terminal 131 to the resize unit 135 as-is.

The image combining unit 134 is substantially the same as the image combining unit 133. That is to say, upon receiving a signal that turns ON the combining processing, the image combining unit 134 combines OSD image data received via the input terminal 132 and captured image data in accordance with a combining ratio indicated by a coefficient A in the OSD image data, and outputs the combining result to the resize unit 136. On the other hand, upon receiving a signal that turns OFF the combining processing, the image combining unit 134 outputs the captured image data input from the input terminal 131 to the resize unit 136 as-is.

Accordingly, the present second embodiment can set whether to superimpose OSD with respect to each display device in addition to the advantageous effects achieved by the first embodiment described earlier.

### Third Embodiment

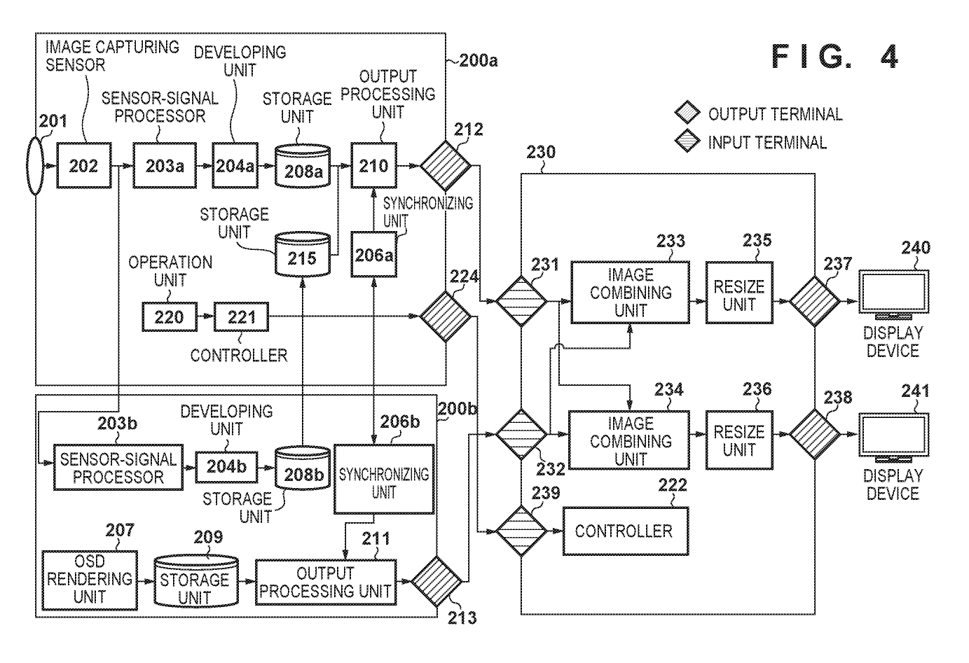

FIG. 4 is a block diagram showing an exemplary configuration of the image processing system according to a third embodiment. The present third embodiment will be also described as being applied to a video camera by way of example. FIG. 4 is a system configuration diagram according to the third embodiment, and image processing devices 200a, 200b, and 230 are included. Each of them can be installed as an SPGA.

The image processing device 200a and the image processing device 200b shown in FIG. 4 divide one piece of captured image data of a subject into two regions, and apply development processing to the regions that are respectively assigned thereto in parallel. For example, the image processing device 200a applies the development processing to an upper half of the result of dividing the captured image data into upper and lower regions, whereas the image processing device 200b applies the development processing to a lower half of the captured image data. Accordingly, the two (plurality of) image processing devices share a processing amount, thereby making possible development processing for a captured image with a much higher resolution than ever. Note that the two image processing devices may share processing by dividing the captured image data into left and right regions, or the two image processing devices may share processing with respect to data of odd-numbered lines and data of even-numbered lines.

Although each constituent element is given a reference sign in the 200s in FIG. 4, the last two digits thereof match the last two digits of its counterpart in FIG. 3. Constituent elements shared by the image processing devices 200a, 200b that execute the development processing are given the indexes a, b for distinction. Therefore, a description of each constituent element will be omitted.

In FIG. 4, a controller 221 includes a CPU and a memory that stores control programs executed by the CPU, and controls the entire processing of the image processing devices 200a, 200b. An operation unit 220 includes input devices, such as keys, buttons, and a touchscreen that are used by a user to issue an instruction to the image processing devices 200a, 200b. An operation signal from the operation unit 220 is detected by the controller 221, and the controller 221 performs control to execute a performance corresponding to an operation. The controller 221 also supplies a signal for display devices 240, 241 that has been set by the operation unit 220 and indicates whether to combine OSD to the image processing device 230 via an output terminal 224.

Upon issuance of an instruction for starting a shooting performance via the operation unit 220, an optical image of a subject targeted for image capture is input via an image capturing optical unit 201 and formed on an image capturing sensor 202. An electrical signal converted by the image capturing sensor 202 is supplied to a sensor-signal processor 203a and a sensor-signal processor 203b, and each of these processors executes pixel restoration processing. The restoration processing includes processing for, with respect to values of missing pixels and pixels with low reliability in the image capturing sensor 202, interpolating pixels to be restored using surrounding pixel values and subtracting a predetermined offset value. Development processing units 204a, 204b apply, to data output from the sensor-signal processors 203a, 203b, so-called development processing for image optimization including, for example, conversion into signals composed of luminance and chrominance, removal of noise included in each signal, and correction of optical distortion. Captured image data after the development is temporarily retained in storage units 208a, 208b. The captured image data retained in the storage unit 208b is transferred to a storage unit 215 within the image processing device 200a. One typical form of the storage units 208a, 208b, 215 is a DRAM. Under control of a synchronizing unit 206a, an output processing unit 210 reads out image data from the storage units 208a, 215 in accordance with a preset timing and outputs the image data to the image processing device 230 via an output terminal 212. In the present embodiment, it is assumed that the image processing device 200a and the image processing device 200b apply the development processing to the upper half and the lower half, respectively. Therefore, the output processing unit 210 switches between units from which it performs readout, namely the storage units 208a, 215, depending on whether the target is the upper half or the lower half.

In accordance with an instruction from the operation unit 220, an OSD rendering unit 207 renders a menu to be displayed, ruling lines for shooting assistance, a timecode, and so on. OSD image data rendered by the OSD rendering unit 207 is temporarily retained in a storage unit 209. One typical form of the storage unit 209 is a DRAM. In accordance with a synchronization timing signal from a synchronizing unit 206b, an output processing unit 211 reads out OSD image data from the storage unit 209 and outputs the OSD image data to the image processing device 230 via an output terminal 213. The synchronizing units 206a and 206b can be brought into synchronization with each other.

A description is now given of the image processing device 230. This image processing device 230 receives, as input, captured image data from the image processing device 200a and OSD image data from the image processing device 200b, and executes combining processing. Then, the image processing device 230 resizes the captured image data after the combining in accordance with resolutions of the display devices 240, 241, and outputs the resized data to these display devices. A controller 222 receives, as input, a signal related to ON/OFF of OSD from the image processing device 200a via an input terminal 239, and controls image combining units 233, 234 in a manner similar to the second embodiment.

An input terminal 231 receives captured image data output from the output terminal 212 of the image processing device 200a. An input terminal 232 receives OSD image data output from the output terminal 213 of the image processing device 200b. The image combining unit 233 and the image combining unit 234 combine the captured image data and the OSD image data. The synchronizing units 206a, 206b can perform timing control so as to minimize a wait period for combining the captured image data and the OSD image data. A resize unit 235 resizes the output from the image combining unit 233 into an angle of view (resolution) corresponding to a request from the display device 240, and outputs the resultant output to the display device 240 via an output terminal 237. Similarly, a resize unit 236 resizes the output from the image combining unit 234 into an angle of view corresponding to a request from the display device 241, and outputs the resultant output to the display device 241 via an output terminal 238.

With the foregoing configuration, the storage units 208a, 208b, 215 store only captured image data, and the storage unit 209 stores only OSD image data. Regardless of the number of the display devices, these storage units are accessed only to perform readout once in a display period of one captured frame; this makes it possible to suppress a strain on bands for accessing these storage units.

### Fourth Embodiment

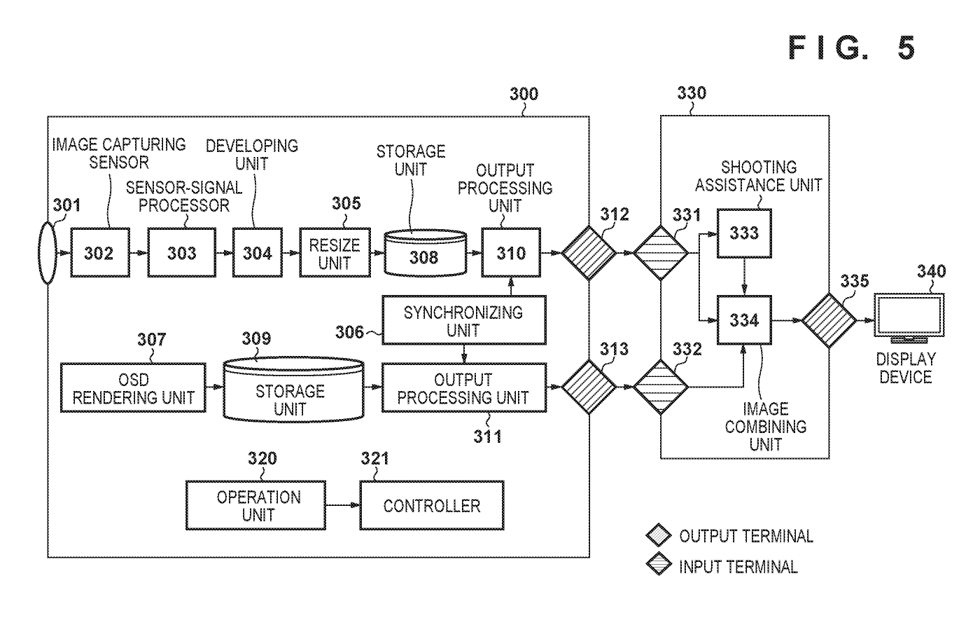

A fourth embodiment will now be described. The present fourth embodiment will be also described as being applied to a video camera by way of example. FIG. 5 is a block diagram showing an exemplary configuration of the image processing system according to the fourth embodiment, and image processing devices 300, 330 can be installed as SPGAs in the video camera.

In the present fourth embodiment, a shooting assistance function (appending assistant image data and image data for a vectorscope) that is not installed in the image processing device 300 and cannot be generated from image data combined with OSD is realized using the other image processing device 330.

A controller 321 in the image processing device 300 includes a CPU and a memory that stores control programs executed by the CPU, and controls the entire processing of the image processing device 300. An operation unit 320 includes input devices, such as keys, buttons, and a touchscreen that are used by a user to issue an instruction to the image processing device 300. An operation signal from the operation unit 320 is detected by the controller 321, and the controller 321 performs control to execute a performance corresponding to an operation.

Upon issuance of an instruction for starting a shooting performance via the operation unit 320, an optical image of a subject targeted for image capture is input via an image capturing optical unit 301 and formed on an image capturing sensor 302. An electrical signal converted by the image capturing sensor 302 is supplied to a sensor-signal processor 303. The sensor-signal processor 303 converts the input electrical signal into digital data, and executes pixel restoration processing. The restoration processing includes processing for, with respect to values of missing pixels and pixels with low reliability in the image capturing sensor 302, interpolating pixels to be restored using surrounding pixel values and subtracting a predetermined offset value. Upon receiving data output from the sensor-signal processor 303, a development processing unit 304 executes so-called development processing for image optimization including, for example, conversion into signals composed of luminance and chrominance, removal of noise included in each signal, and correction of optical distortion. Captured image data obtained through the development is supplied to a resize unit 305. The resize unit 305 resizes the input captured image data into an angle of view (resolution) corresponding to an external output device, and temporarily stores the resized captured image data to a storage unit 308. One typical form of the storage unit 308 is a DRAM. In accordance with an instruction from a synchronizing unit 306, an output processing unit 310 reads out captured image data from the storage unit 308 at a set timing and outputs the captured image data to the image processing device 330 via an output terminal 312.

In accordance with an instruction from the operation unit 320, an OSD rendering unit 307 renders a menu to be displayed, ruling lines for shooting assistance, a timecode, and so on. OSD image data rendered by the OSD rendering unit 307 is temporarily stored to a storage unit 309. One typical form of the storage unit 309 is a DRAM. In accordance with an instruction from the synchronizing unit 306, an output processing unit 311 reads out OSD image data from the storage unit 309 at a set timing and outputs the OSD image data to the image processing device 330 via an output terminal 313.

The image processing device 330 adds shooting assistance data by processing the captured image data and the OSD image data output from the image processing device 300, and outputs the resultant image to a display device 340.

An input terminal 331 receives the captured image data output from the output terminal 312. An input terminal 332 receives the OSD image data output from the output terminal 313. A shooting assistance unit 333 generates data necessary for shooting assistance from the captured image data, for example, data that realizes a waveform monitor function, a vectorscope function, and so on. An image combining unit 334 combines the captured image data, the OSD image data, and the shooting assistance data. The synchronizing unit 306 can perform timing control so as to minimize a wait period for combining image data and OSD data. The image data combined by the image combining unit 334 is output to the display device 340 via an output terminal 335.

As described above, according to the present fourth embodiment, the shooting assistance function that is not installed in the image processing device 300 and cannot be generated from image data combined with OSD can be realized using the image processing device 330.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-051711, filed on Mar. 16, 2017, which is hereby incorporated by reference herein in its entirety.

What is claimed is:

1. An image processing system, comprising:
a first image processing device including a first output terminal that outputs captured image data obtained through image capture, and a second output terminal that outputs assistant image data to be combined with an image based on the captured image data; and
a second image processing device including a first input terminal connected to the first output terminal, a second input terminal connected to the second output terminal, a third output terminal connectable to a first display device, and a fourth output terminal connectable to a second display device,
wherein the second image processing device further includes
a combining unit that generates combined image data by combining the captured image data input via the first input terminal and the assistant image data input via the second input terminal, and
a converting unit that generates image data of a first resolution to be output to the third output terminal and image data of a second resolution to be output to the fourth output terminal by converting a resolution of the combined image data generated by the combining unit in accordance with a display resolution of the first display device and a display resolution of the second display device.

2. The system according to claim 1,
wherein the converting unit includes
a first sub-converting unit that generates the image data of the first resolution by converting the resolution of the combined image data generated by the combining unit, and outputs the image data of the first resolution to the third output terminal, and
a second sub-converting unit that generates the image data of the second resolution by converting the resolution of the combined image data generated by the combining unit, and outputs the image data of the second resolution to the fourth output terminal.

3. The system according to claim 1, wherein
the first display device is an electronic viewfinder, and
the second display device is a liquid crystal panel.

4. The system according to claim 1,
wherein the first image processing device further comprises
an image capturing unit that captures an image of a subject,
a developing unit that executes development processing to image data obtained through image capture in parallel,
a first storage unit that stores the captured image data obtained through the development processing,
a rendering unit that generates the assistant image data by rendering the assistant image data,
a second storage unit that stores the assistant image data generated by the rendering unit, and
an output unit that reads out the captured image data stored in the first storage unit and the assistant image data stored in the second storage unit in synchronization, outputs the captured image data that has been read out to the first output terminal, and outputs the assistant image data that has been read out to the second output terminal.

5. The system according to claim 1,
wherein the first image processing device further comprises
an operation unit that receives, from a user, input of an instruction related to whether to combine the assistant image data with respect to each of the first and second display devices, and
a first controller that supplies setting information corresponding to the input of the instruction to the second image processing device,
wherein the combining unit of the second image processing device comprises
a first sub-combining unit that generates first combined image data by combining the captured image data input via the first input terminal and the assistant image data input via the second input terminal, and
a second sub-combining unit that generates second combined image data by combining the captured image data input via the first input terminal and the assistant image data input via the second input terminal,
wherein the converting unit comprises
a first sub-converting unit that converts a resolution of the first combined image data generated by the first sub-combining unit in accordance with the display resolution of the first display device, and outputs the image data of the first resolution, and
a second sub-converting unit that converts a resolution of the second combined image data generated by the second sub-combining unit in accordance with the display resolution of the second display device, and outputs the image data of the second resolution, and
wherein the second image processing device further comprises
a second controller that controls whether to execute combining processing in each of the first and second sub-combining units based on the setting information supplied from the first controller.

6. The system according to claim 1,
wherein the first image processing device further comprises
an image capturing unit that captures an image of a subject,
a plurality of developing units that divide image data obtained through image capture into a plurality of regions, and perform development processing to each of the regions in parallel,
a plurality of storage units that respectively store pieces of post-development image data obtained by the plurality of developing units, and
an output unit that reads out the one-piece post-development captured image data from the pieces of post-development image data of the respective regions stored in the plurality of storage units, and outputs the captured image data to the first output terminal.

7. The system according to claim 6, wherein
the first image processing device is installed as a plurality of integrated circuit chips in an image capturing apparatus, and
each of the plurality of integrated circuit chips includes one developing unit and one storage unit.

8. The system according to claim 1, wherein
each of the first image processing device and the second image processing device is installed as an integrated circuit chip.

9. An image processing system, comprising:
a first image processing device including a first output terminal that outputs captured image data obtained through image capture, and a second output terminal that outputs first assistant image data to be combined with an image based on the captured image data; and
a second image processing device including a first input terminal connected to the first output terminal, a second input terminal connected to the second output terminal, and a third output terminal connectable to a display device,
wherein the second image processing device further comprises
a second assistant image generation unit that generates second assistant image data for assisting image capture from the captured image data input via the first input terminal, and
a combining unit that generates combined image data to be output to the third output terminal by combining the captured image data input via the first input terminal, the second assistant image data generated by the second assistant image generation unit, and the first assistant image data input via the second input terminal.

10. The system according to claim 9, wherein
the second assistant image generation unit generates the assistant image data for a waveform monitor or a vectorscope from the captured image data.

11. The system according to claim 9, wherein
each of the first image processing device and the second image processing device is installed as an integrated circuit chip.
